(19) United States
(12) Patent Application Publication
(10) Pub. No.: US 2024/0252018 A1
(43) Pub. Date: Aug. 1, 2024

(54) Kontryman Boot Hanger

(71) Applicant: Cartail Quentin Alexander, SR., Denham Springs, LA (US)

(72) Inventor: Cartail Quentin Alexander, SR., Denham Springs, LA (US)

(21) Appl. No.: 18/103,418

(22) Filed: Jan. 30, 2023

(51) Int. Cl. A47L 23/20; B60R 7/10

(52) U.S. Cl. CPC A47L 23/20; B60R 7/10; B60R 2011/0036; B60R 2011/0059

(57) ABSTRACT

The boot hanger is designed to provide longevity support and functional use for boots or any other footwear. The utility device is created to hold boots on hooks while airflow penetrates the inner boot generating natural air circulation as a drying process. The inventive device has a hook block with two locking bolts for securing and fastening, attached by two outward-facing L-shaped levels.

### BACKGROUND OF THE INVENTION

### Field of Invention

The present invention generally relates to the shoe rack. The shoe rack supports footwear with space; however, the main objective of the shoe rack is limited in function to what consumers need. Therefore, there is a need within this field of art for improvement.

### Description of the Prior Art

Currently, there has been no known evidence of prior art.

### SUMMARY OF THE INVENTION

The primary objective of the boot hanger is to provide support and better operation of footwear, particularly boots. The boot hanger is designed for all footwear and boots up to size 14. When used correctly, this device will prevent ankle and foot damage and provide optimum performance as the life span of boots. One goal is to preserve healthy boots as well-conditioned quality boots minimize workplace injuries.

Another objective of the boot hanger is to reduce unnecessary spending on new boots, most workers place boots in the tight spaces between the back of the truck and the front cargo. This causes the life span of boots to deteriorate as the boot hanger preserves boots for optimum performance.

The further objective of the boot hanger is to provide quick access to the boots while minimizing the use of storage space in the truck's cargo area. The device can be placed on the back seat of an SUV. Also, this keeps the boots from getting lost.

An additional objective of the boot hanger is to keep the worker's boot well-ventilated with natural airflow while localized on a stationary device.

Additional articles and the defined use of the invention will appear as the description is written. To the designed functionality of the related objects, this invention may be represented further in a graphic illustration format by detailed segments, attention being called to the fact, however, that the drawings are illustrative only, and that changes may be made in the specific construction illustrated and described within the scope of the appended claims.

### BRIEF DESCRIPTION OF THE DRAWINGS

Demonstrated objects, features, and distinctive advantages of the present invention will become fully gauged as giving descriptions are emphasized with the related drawings, as to similar reference characters designate the same or like parts throughout the several views, and wherein:

FIG. 1 is a front view of the invention with all components.

FIG. 2 is an underneath and side view of the present invention with all components.

FIG. 3 is a view of the channel box of the front and side.

FIG. 4 is a magnified perspective view of the left hanger.

FIG. 5 is a magnified perspective view of the right hanger.

FIG. 6 is a view of bolts (left and right) and font side holes.

### DESCRIPTION OF THE PREFERRED EMBODIMENT

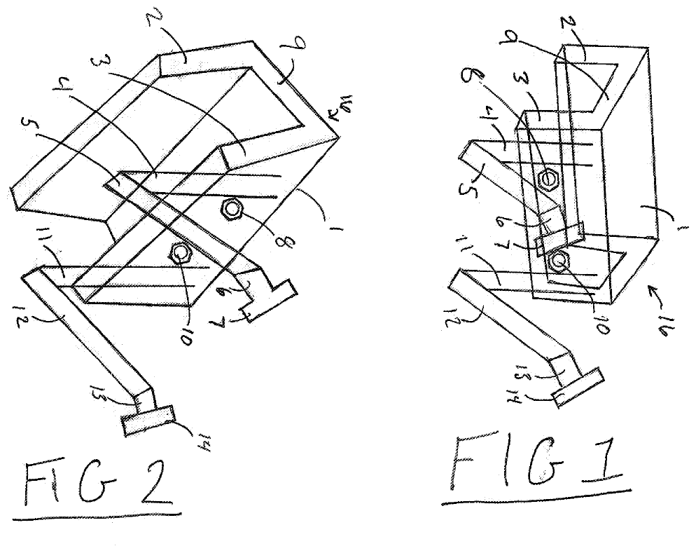

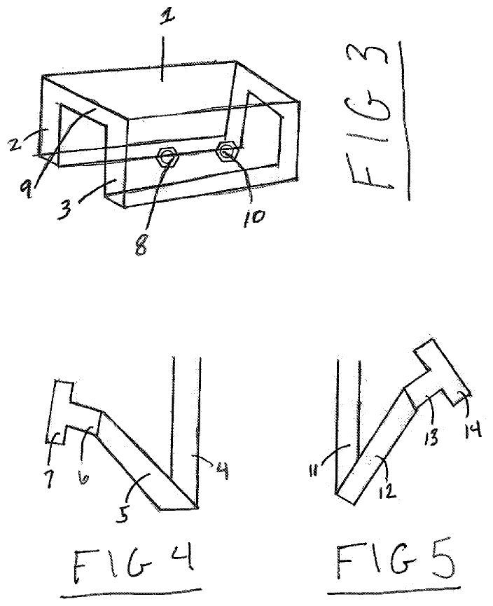

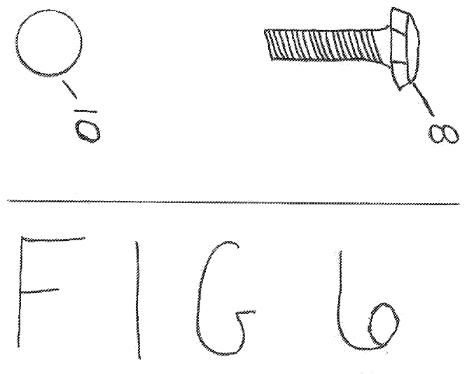

Forwarding to the descriptive drawing details in which similar references are expressed in nature of similar aspects of several viewpoints. FIGS. 1 and 2 illustrate all components of the boot hanger, composing of ninety-five percent of high-density polyethylene plastic (HDPE), 16 comprises all components wherein, 1 a stationary base channel block, 2 is the back leg of the base channel, 3 is front leg of the base channel, and 9 fixed as center of base channel. FIGS. 3 through 5 are the dissection of the boot hanger, 1, a stationary-base channel with 8 of FIG. 6 comprise of both locking bolts sizing 0.75 inches, placed inside of 10 a 1-inch hole of 3 the stationary-base front leg. FIG. 4 is the left L-shaped hanger comprises of 4 straight handle, 5 elbow, 6 level, and 7 balancer. FIG. 5 right L-shaped hanger comprises of 11 straight handle, 12 elbow, 13, level, and 14 balancer.

As shown best in FIG. 1 of the drawing, the straight handles 4 and 11 more defined in FIGS. 4 and 5 are plastic welded onto the front leg of the base channel 3. Attached to straight handle 4, is 5 the elbow, 6 level, and 7 balancer as to straight handle 11, 12 elbow, 13 level, and 14 balancer. As in with use as described, both FIGS. 4 and 5 left and right hangers are designed on a 60-degree angle and to withhold up to a standard 14-inch steel toe boot with 1 fixed onto the truck railing of 1.5 to 3.5 in width securing the device by both 8 bolts fastened to the inner truck liner. The typical space between the cab and truck bed ranges from 1 inch to 1.5 inches; 2 of FIGS. 1 and 2 are fabricated for placement within the space. For balancing weight structure, FIGS. 1 and 2 align portions of 1 stational-base channel, 9 counters balance total weight, 2 and 3 front, and back legs to support the level of tension.

As to a further discussion of the manner of usage and operation of the present invention, the same should be apparent from the above description. Accordingly, no further discussion relating to the manner of usage and operation will be provided.

As stated in the description given, the relationships and expression to proportional parts of the invention, including variations in size, materials, shape, form, function and manner of operation, assembly, and use, are deemed readily apparent.

Further, since numerous modifications and changes will readily occur due to automobile innovation, it is not desired to limit the invention to the exact construction and operation shown and described, and accordingly, all suitable modifications and equivalents may be resorted to, falling within the scope of the invention.

I claim:

1. A boot hanger is referred to as a channel block comprising:
a material of ninety-five percent high-density polyethylene plastic (HDPE); and
having a stationary base with 2 extended hangers and mechanical fasteners for locking; and
performs in optimum use to append footwear upright.

2. The boot hanger of claim 1, wherein said stationary base is rectangular in shape has said back and front legs and said center for positioning channel block to a truck bed.

3. The boot hanger of claim 2, wherein said stationary base has said 1-inch holes located in the channel block front leg. To the stationary base, the mechanical fasteners (2-bolts) sizing 0.75 inches are designed to enter both holes to secure the channel block to the point of location to such areas as a truck bed or SUV back seat.

4. The boot hanger of claim 3, wherein said channel block comprises of a front leg that is plastic wielded to right and left hangers.

5. The boot hanger of claim 4, wherein the left hanger is composed of said straight handle, elbow, level, and balancer.

6. The boot hanger of claim 5, wherein the right hanger is composed of said straight handle, elbow, level, and balancer.

7. The boot hanger of claim 6, Said balancers are wielded vertically on the level of both hangers to stabilize the footwear or boots.

8. The boot hanger of claim 7, wherein said left and right hangers are flung outward on a 60-degree angle and said level positioned at a 10-degree angle, both said angles are designed to stable footwear or a boot for holding.
